(19) United States
(12) Patent Application Publication
(10) Pub. No.: US 2019/0274326 A1
(43) Pub. Date: Sep. 12, 2019

(54) PROCESS FOR THE PRODUCTION OF CHEESE

(71) Applicant: DMK Deutsches Milchkontor GmbH, Zeven (DE)

(72) Inventors: Henk VAN DER VELDE, Haskerhorne (NL); Ralf MANKIEWITZ, Holtsee (DE); Deyk TIEDEMANN, Nieder Ochtenhausen (DE)

(21) Appl. No.: 16/298,262

(22) Filed: Mar. 11, 2019

(30) Foreign Application Priority Data
Mar. 12, 2018 (EP) 18 161 200.3

(51) Int. Cl. A23C 19/068; A23C 19/05; A23C 9/14; A23C 3/02; A23C 9/13

(52) U.S. Cl. CPC A23C 19/0688; A23C 19/05; A23C 9/1322; A23C 3/02; A23C 9/14

(57) ABSTRACT

A process for the production of cheese is suggested, comprising or consisting of the following steps:
(i) providing milk;
(ii) coagulation of the milk while adding starter cultures and/or rennet material;
(iii) separation of the coagulated milk of step (ii) into whey and curd;
(iv) processing the whey obtained in step (iii) with fine curd particles contained therein into a stable suspension; and
(v) further processing of the curd obtained in step (iii) into cheese,
characterised in that
(a) before the separation of whey and curd, the process contains a further step, wherein milk is subjected to filtration and/or bactofugation, obtaining a bacterial concentrate and a treated milk;
(b) the bacterial concentrate obtained in step (a) is sterilised, and the sterilised bacterial concentrate is re-added to the treated milk; and
(c) the suspension produced in step (iv) is either added to the bactofugate obtained in step (a), or is added to the sterilised bacterial concentrate obtained in step (b).

### FIELD OF THE INVENTION

The invention is in the field of dairy and cheese products and relates to an improved process for the production of cheese, specifically of semi-hard cheese or hard cheese.

### STATE OF THE ART

The history of cheese making dates back to the early Neolithic age. This makes cheese one of the oldest foods made by man. Accordingly, its production has been performed in substantially the same manner for millennia: milk is allowed to curdle by adding lactic acid cultures and rennet (“coagulation”), and the liquid phase, or whey, released in this process is separated from the colloidal-to-solid residue. The coagulated liquid (“soured milk”) continues to dehydrate and is then mechanically comminuted, obtaining the so-called curd. The curd is processed by means of pre-pressing, shaping and various maturing processes, eventually obtaining the final product.

A known problem in cheese production is that quite a significant amount of fine curd particles having a mean diameter of 0.1-2 mm is separated together with the whey. It is possible to recover the so-called “cheese fines” by means of corresponding separators, but this is technically complex. It would be preferred to recirculate the particles into the cheese-making process, as they are, in principle, a valuable source of protein. However, the particles are then found to reappear in the whey and not in the curd. This leads to the situation that the cheese fines are usually processed to processed cheese or animal feed. In this context, for example, it is particularly referred to page 103 in CARAWAN ET AL “Dairy Processing Water and Waste Water Management” in EXTENSION SPECIAL REPORT NO. AM-18b (1979), published by The North Carolina Agricultural Extension Service.

However, German patent application DE 103 48 733 A1 (CAMPINA) discloses a process relating to the problem described, wherein the fine curd particles that are separated together with the whey are re-circulated into the cheese-making process. In doing so, whey is subjected to mechanical homogenisation, comminuting the particles contained therein up to a maximum size of 250 μm so that they cease to deposit in the liquid. The suspension is then added to the cheese milk, i.e., the standardised milk. The standard milk enriched in this manner is subsequently pasteurised and fermented.

However, during the post-processing of this method applicant found that it lead to quite unsatisfactory results only. In particular, inter alia, in the described procedure it was observed that thermophilic germs and bacteriophages accumulated despite the pasteurising step, thus heavily contaminating the product, especially when the process was continuously operated, as is customary, such that the regulatory requirements for marketing and consumption are no longer fulfilled.

The object of the present invention was, therefore, to amend the above-described process such that microbiologically safe products are obtained also in a continuous process.

### DESCRIPTION OF THE INVENTION

The subject matter of the invention is a process for the production of cheese, comprising or consisting of the following steps:
(i) providing milk;
(ii) coagulating the milk while adding starter cultures and/or rennet material;
(iii) separation of the coagulated milk of step (ii) into whey and curd;
(iv) processing the whey obtained in step (iii) with the fine curd particles contained therein into a stable suspension; and
(v) further processing of the curd obtained in step (iii) into cheese,
   which is characterised in that
(a) before the separation of whey and curd, the process contains a further step, wherein the milk is subjected to filtration and/or bactofugation, obtaining a bacterial concentrate and a treated milk;
(b) the bacterial concentrate obtained in step (a) is sterilised, and the sterilised bacterial concentrate is re-added to the treated milk; and
(c) the suspension produced in step (iv) is either added to the bacterial concentrate obtained in step (a) or to the sterilised bacterial concentrate obtained in step (b).

As is shown in the following experimental section, the introduction of bactofugation and sterilisation as additional steps, and the feeding of the cheese particle suspension into the bacterial concentrate result in the obtainment of a practically bacteria-free and, therefore, a microbiologically safe product.

### BRIEF DESCRIPTION OF THE DRAWING

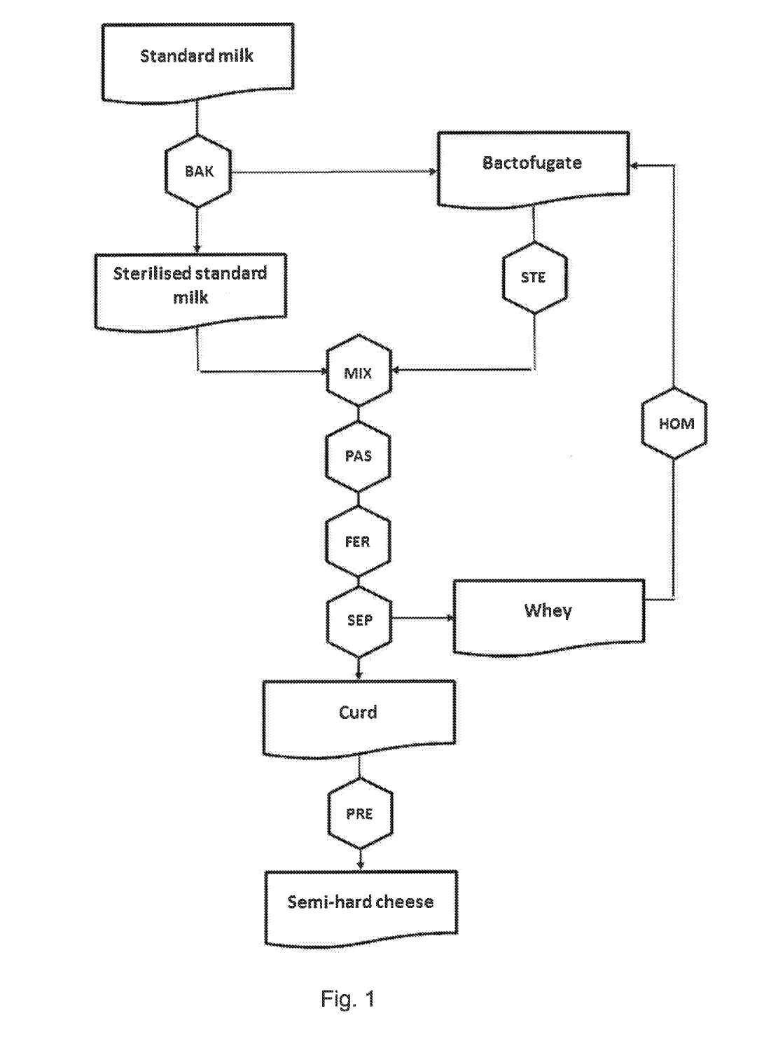

The present invention will be described in greater detail with reference to the accompanying drawing in which FIG. 1 illustrates a flow chart of the process according to the present invention

### INGREDIENTS, STANDARDISATION AND PASTEURISATION

Suitable ingredients for the production of cheese, specifically of semi-hard cheese or hard cheese, comprise raw milk, semi-skimmed milk and particularly skimmed milk, wherein the fat content is preferably within the range of about 1 to about 5% by weight.

A particularly preferred ingredient is the so-called standard milk (also referred to as standardised milk). It is one of the above ingredients which is adjusted to a defined fat content or protein content by adding, for example, cream (“standardisation”). To this end, a fat-to-protein ratio of about 0.2 to about 1.2 is usually employed.

Standardisation is followed by pasteurisation. The latter is usually performed such that the milk is heated to a temperature of about 70 to 80° C. and particularly of about 72 to 74° C. for a residence time of 10 seconds minimum and 60 seconds maximum, preferably for about 30 seconds.

### Sterilisation

Both non-standardised and standardised milk contains germs, particularly thermophilic spores which are, among other things, detrimental to the human health and have to be removed by suitable measures according to the relevant statutory regulations, but also in order to improve the quality. This is typically performed by filtration or bactofugation.

In the process of bactofugation, milk is separated into a low-germ fraction and a bacterial concentrate (“bactofugate”) in a centrifuge (“bactofuge”). The bactofugate (or, more generally, bacterial concentrate), however, does not constitute a waste product, but is merely a highly contaminated milk. Therefore, the concentrate is subjected to a sterilisation step at more than 100° C., typically at 120 to 140° C., in the process of which all thermophilic germs are killed. Subsequently, the sterilised phase may be added to the low-germ phase, so that, in practice, no amount of milk is lost. In short, a type of milk is produced in this manner, which has such a low germ load that it is does not pose any health risks and complies both with the legal requirements and the quality standards. The blended product of low-germ milk and sterilised bacterial concentrate obtained in this manner is referred to as milk in the vat or cheese milk within the meaning of the present invention.

### Coagulation and Separation

Coagulation of (standardised) milk is performed by adding starter cultures and/or rennet material. Suitable are typical lactic acid cultures such as, for example, Leuconostoc sp. or Lactococcus sp., which are well known to the skilled person. In addition, rennet is added to the milk, which is a natural mixture of the enzymes chymosin and pepsin. The respective amounts are within the range of about 2 to about 5 g/100 L cheese milk, and preferably at about 5 g/100 L cheese milk—based on the milk in the vat or cheese milk. The starter cultures and the enzymes cause the pH value to decrease, and the milk protein is precipitated.

Further, calcium chloride may be fed into the fermentation process in order to facilitate gelation in this manner. Usually, solutions of 10 to 35% by weight are employed in amounts from about 10 to about 200 g/100 litres of milk where the preferred amounts range from about 80 to about 120 g/100 litres.

Separation may also be performed in a conventional manner, in the process of which the pressing out of whey, which is typical for the production of semi-hard cheese, is not very suitable. Instead, simple sieves or, preferably, drainage belts, pre-pressing vats or a so-called Casomatic system are suitable for this purpose.

### Homogenisation and Suspension Additive

Usually, the whey formed during coagulation may still contain various amounts of fine curd particles. It is, in principle, a valuable product which is typically lost together with the low-value whey, or is separated in the separators and is used as a good of lower value, for example, for the production of processed cheese.

However, an essential finding of the present invention was that just this material which is rather considered a kind of waste material has the property of significantly improving the thermo-physical properties of semi-hard cheese or hard cheese. To this end, it is, however, particularly advantageous to homogenise the particles, as a homogeneous distribution of particles has a particularly beneficial effect on product properties. Herein, the term homogenisation has the same meaning as the comminution of differently sized particles to a uniform size.

In the simplest case, homogenisation may be performed directly within the whey.

In a first alternative embodiment, the whey with fine curd particles contained therein may also be subjected to conditioning, in which the whey is wholly or partly removed and/or exchanged for or mixed with water, another dairy product, or a dairy-based product. Subsequently, the intermediate product such obtained is homogenised. This means, in particular, that the whey is skimmed in a separator, the curd particles are separated (“removal of cheese fines”) and collected by decanting.

In a further embodiment, it is possible to subject the whey with fine curd particles contained therein to conditioning, in which
whey is wholly or substantially separated;
the resulting dry or substantially dry (with a residual moisture content of 5% by weight) curd particles are re-suspended in water or in another dairy-based product, and
the suspension such obtained is subjected to homogenisation.

Homogenisation or comminution of the fine curd particles may be performed in various manners, i.e., mechanically, thermally, or (bio)chemically, or by a combination of two processes. As the curd particles have a particle size distribution with the largest particles having a diameter of about 1 to 2 mm, homogenisation is necessary for comminution.

Mechanical comminution may be performed using means such as a homogeniser, a colloid mill, a ball mill, a high shear mixer and a disc mill, but it is also possible to employ ultrasound techniques. Among these mechanical means, the disc mill provided good results. A disc mill is a device in which two aluminium oxide discs are set up in parallel within a short distance from one another, rotating in opposite directions. A suspension with fine curd particles contained therein is continuously supplied between the discs under pressure and the fine curd particles are comminuted by the discs rotating in opposite directions. The distance of the discs has an impact on the maximum size of the comminuted fine curd particles eventually obtained.

Thermal comminution is particularly preferred in this context, i.e., through the formation of cavitation where the particles are caused to implode.

In principle, also chemical or biochemical processes are considered where the particles are initially dissolved and then aggregated. This requires, however, a considerable effort and is, therefore, less preferred.

For the purpose of the invention it is useful to add the homogenised curd particles to the bactofugate or the sterilisation product thereof in the form of a stable suspension. This is understood as meaning that the particles are present in the liquid phase in a stable suspension, and that they do not form sediments containing particles having a diameter of less than 250 μm, preferably less than 150 μm. Consequently, the particles had been ground or homogenised to this size before.

It also proved to be advantageous to add suspensions having a portion of solid curd particles within the range of about 1 to about 10% by weight. In suspensions of a higher concentration there is a higher risk of a deposition of sediments.

According to the invention, the suspensions are not added to the milk in the vat or cheese milk, but to the bactofugate or the sterilised bactofugate. The first alternative is preferred here, because this manner ensures that no germs are introduced. In doing so, amounts of about 1 to about 10% by weight are typically added, while this quantity refers to the curd content in the suspension on the one hand and to the treated milk the sterilised bactofugate is optionally added to on the other. Lower amounts may also be possible, but are not very economical, whereas larger amounts may lead to a bonding of the structures of the semi-hard cheese and the hard cheese.

### Further Processing

Further processing of the curd to the final product may be performed in a manner known in itself. This includes pressing out the adhering whey. Subsequently, the cheese is, optionally, stored in brine, coated with cheese wax and further substances, and is ready for consumption after a maturation time of about 6 weeks.

### EXAMPLES

### Example 1

### Production of a Stable Curd Particle Suspension in Whey

100 L whey from the coagulation of cheese milk were separated from the curd using a drainage belt, and the curd particles (with a dry matter content of ca. 5% by weight) contained therein having a size of between 0.01 and 1 mm were ground in a colloid mill to a mean particle size of about 150 μm.

### Example 2

### Production of a Stable Curd Particle Suspension in Skimmed Milk

100 L whey from the coagulation of cheese milk were separated from the curd using a drainage belt, and the curd particles (with a dry matter content of ca. 5% by weight) contained therein having a size of between 0.01 and 1 mm were ground in a colloid mill to a mean particle size of about 200 m. Subsequently, the whey was washed out and/or mixed with skimmed milk, and the curd particles were re-dispersed in skimmed milk.

### Example 3

### Production of a Stable Curd Particle Suspension in Water

100 L whey was separated as described above and concentrated in a decanter to a dry matter content of about 20% by weight. The adhering whey was washed out and the cheese fines were then re-dispersed in water. Subsequently, the suspension was ground in a colloid mill to a mean particle size of about 150 μm.

### Example 4

### Production of Hard Cheese (According to the Invention)

100 L standardised cheese milk (fat-to-protein ratio of 0.2-1.5) was separated in a bactofuge into 95-99.7 L of a diluted skimmed milk phase and 5 L of bactofugate. 2 L of the homogenised suspension of example 3 were added to the bactofugate, and were homogenised by means of an Ultraturrax, were heated to 130° C. for a period of 20 seconds, and were added to the diluted skimmed milk phase again. 1 g starter culture (acidification inducing bacteria), 5 g rennet and 15 g of a 35% by weight calcium chloride solution were added to the combined product. After coagulation, the whey containing the fine curd particles was separated from the colloidal residue by means of a whey suction device within the finishing device and a Casomatic system, and was further processed as described above. The number of thermophilic germs was determined after adding the sterilised bactofugate to the treated milk, and amounted to <100 KBE/ml.

### Comparison Example V1

### Production of Semi-Hard Cheese (not According to the Invention)

2 L of the suspension of example 3 were added to 100 L standardised skimmed milk (fat-to-protein ratio 0.2-1.5), and were homogenised by means of an Ultraturrax. Subsequently, the mixture was pasteurised at 72° C. for 15 seconds, and 1 g starter culture (acidification inducing bacteria), 5 g rennet and 125 g of a 35% by weight calcium chloride solution were added to it. After coagulation, the whey containing the fine curd particles was separated from the colloidal residue by means of a whey suction device within the finishing device and a Casomatic system, and was further processed as described above. The number of thermophilic germs was determined after pasteurisation and amounted to >500 KBE/ml.

1. A process for the production of cheese, comprising the following steps:
(i) providing milk;
(ii) coagulating the milk while adding starter cultures and/or rennet material;
(iii) separating the coagulated milk of step (ii) into whey and curd;
(iv) processing the whey obtained in step (iii) with fine curd particles contained therein into a stable suspension; and
(v) further processing of the curd obtained in step (iii) into cheese, wherein before separating the whey and curd, the process comprises the further steps:
(a) subjecting milk to filtration and/or bactofugation, obtaining a bacterial concentrate and a treated milk;
(b) sterilising the bacterial concentrate obtained in step (a), and re-adding the sterilised bacterial concentrate to the treated milk; and
(c) adding the suspension produced in step (iv) either to the bactofugate obtained in step (a), or to the sterilised bacterial concentrate obtained in step (b).

2. The process of claim 1, wherein raw milk, semi-skimmed milk or skimmed milk is employed.

3. The process of claim 1, wherein the milk is standardised.

4. The process of claim 3, wherein the milk is adjusted to a fat-to-protein ratio of about 0.2 to about 1.5.

5. The process of claim 1, wherein the standardised milk is subjected to filtration and/or bactofugation.

6. The process of claim 1, wherein the standardised milk is subjected to pasteurisation before or after filtration and/or bactofugation.

7. The process of claim 1, wherein the whey with fine curd particles contained therein obtained in step (iii) is subjected to homogenisation.

8. The process of claim 1, wherein the whey with fine curd particles contained therein obtained in step (iii) is subjected to conditioning, the whey is wholly or partly removed and/or exchanged for or mixed with water, another dairy product, or a dairy-based product, and the intermediate product is subjected to homogenisation.

9. The process of claim 1, wherein the whey with fine curd particles contained therein obtained in step (iii) is subjected to conditioning:
whey is wholly or substantially separated;
the resulting dry, or substantially dry, curd particles are re-suspended in water or in another dairy product; and
the suspension such obtained is subjected to homogenisation.

10. The process of claim 1, wherein homogenisation is performed mechanically and/or thermally and/or (bio)chemically.

11. The process of claim 1, wherein calcium chloride is added in an amount of about 10 to about 200 g/100 litres of milk during fermentation.

12. The process of claim 1, wherein the added suspension contains particles having a diameter of less than 250 μm, preferably less than 150 μm.

13. The process of claim 1, wherein the added suspension has a portion in solid curd particles within the range of about 1 to about 10% by weight.

14. The process of claim 1, wherein the suspension is added in amounts of about 0.5 to about 10% by weight—based on the curd content in the suspension on the one hand, and on the treated milk which the sterilised bacterial concentrate is added to on the other hand.

15. The process of claim 1, wherein the curd obtained in step (iii) is processed into the final product by pressing out adhering whey residues, shaping and maturing.
